(19) United States
(12) Patent Application Publication
(10) Pub. No.: US 2012/0115620 A1
(43) Pub. Date: May 10, 2012

(54) TORQUE LIMITER

(76) Inventors: Kiyoshi IWAMA, Toyota-shi (JP); Hideo ONO, Toyota-shi (JP); Kazuya MORITA, Toyota-shi (JP)

(21) Appl. No.: 13/237,161

(22) Filed: Sep. 20, 2011

(30) Foreign Application Priority Data
Nov. 5, 2010 (JP) 2010-248919

(51) Int. Cl. F16D 7/02

(52) U.S. Cl. 464/46

(57) ABSTRACT

A torque limiter for vehicle includes a first member, a friction plate, a second member, an urging member, a first facing, and a second facing. The first member is connected to a first rotary shaft. The friction plate is connected to a second rotary shaft. The second member is retained on the first member. The urging member presses the second member toward the friction plate. The first facing is retained on a surface of the first member that faces the friction plate. The second facing is retained on a surface of the second member that faces the friction plate. At least one of the first member and first facing includes a first positioner, thereby positioning the former and latter coaxially with each other. At least one of the second member and second facing includes a second positioner, thereby positioning the former and latter coaxially with each other.

### INCORPORATION BY REFERENCE

The present invention is based on Japanese Patent Application No. 2010-248,919, filed on Nov. 5, 2010, the entire contents of which are incorporated herein by reference.

### BACKGROUND OF THE INVENTION

1. Field of the Invention

The present invention relates to a torque limiter that is used for dampers for hybrid driving system.

2. Description of the Related Art

A hybrid driving system adopts each of an engine and an electric motor as a driving source. In such a hybrid driving system having a plurality of driving sources, torque fluctuations are more likely to occur than in driving systems in which one and only driving source is present. Consequently, hybrid driving systems employ torque-fluctuation absorbers that posses a function of keeping the torque fluctuations down between the engine and the electric motor.

For example, Japanese Unexamined Patent Publication (KOKAI) Gazette No. 9-226,392 discloses a technique for inhibiting the torque fluctuations, which result from an engine and electric motor, by means of dampers that comprise elastic members, such as springs or rubbers. However, when the torque fluctuates excessively, it is necessary to make the inhibitor capacity of the elastic dampers greater. On the other hand, when the inhibitor capacity of the elastic dampers declines gradually, it is necessary to set up the strength of the respective constituent elements of the engine and electric motor greater because each of the two driving sources comes to receive the torque fluctuations directly.

Hence, Japanese Unexamined Patent Publication (KOKAI) Gazette No. 2002-13,547 discloses a damper for hybrid driving system, damper which is provided with a torque limiter. The torque limiter interrupts the power transmission between two driving sources when a torque fluctuation resulting from the two driving sources reaches a predetermined value. FIG. 11 illustrates a schematic construction of the torque limiter disclosed in the publication. The torque limiter is disposed between an engine and an electric motor, and is then put in place on an outer peripheral side of a damper 100.

The damper 100 is connected to a second rotary shaft 200, and the second rotary shaft 200 is then connected to the rotary shaft of an electric motor by way of a not-shown planetary gear train. The damper 100 is made displaceable axially, because it is combined with the second rotary shaft 200 by means of spline. The torque limiter has a flat ring-shaped core plate 101, which is fixed on an outer peripheral surface of the damper 100. Facings (102, 102) are bonded on the opposite faces of the core plate 101, respectively. The core plate 101 is put in place between a first rotary member 104 and a second rotary member 105. The first rotary member 104 is connected to an engine's output shaft 103 that is coaxial with the second rotary shaft 200, and is driven to rotate together with the output shaft 103. The second rotary member 105 is retained to the first rotary member 104, but is made relatively movable, with respect to the first rotary member 104, in an axial direction. A coned disk spring 106 is put in place on the back face of the second rotary member 105, and is pressed by a fixture plate 107 that is fixed to the first rotary member 104. Thus, one of the two facings (102, 102) being bonded on the opposite faces of the core plate 101 is always pressed onto the first rotary member 104, whereas the other one of the two is always pressed onto the second rotary member 105.

In a hybrid driving system with the thus constructed conventional torque limiter, the rotations of the engine's output shaft 103 is transmitted to the damper 100 as they are when the torque fluctuations fall in a range where they are smaller than a predetermined value. Then, the damper 100 transmits the rotations of the engine's output shaft 103 to the second rotary shaft 200 while a not-shown elastic member, with which the damper 100 is provided, undergoes elastic deformations in compliance with the torque fluctuations. On the other hand, when the torque fluctuations exceed the predetermined value, the facings (102, 102) start sliding with respect to the first rotary member 109 and second rotary member 105, and thereby the damper 100 comes not to transmit the torque fluctuations, which are the predetermined value or more, to the second rotary shaft 200. Since the second rotary member 105 is movable relatively, with respect to the first rotary member 104, in an axial direction, and since the core plate 101 is made movable together with the damper 100 in the axial direction, the urging force of the coned disk spring 106 displaces the second rotary member 105 and core plate 101 in the axial direction as the facings (102, 102) wear down.

In the aforementioned conventional torque limiter, the facings (102, 102) are bonded on the core plate 101 with an adhesive agent. However, since both the core plate 101 and the facings (102, 102) have a flat ring-shaped configuration, respectively, the conventional torque limiter might have such a drawback that it is difficult to position and align the facings (102, 102) coaxially with respect to the core plate 101 highly accurately upon bonding the facings (102, 102) onto the core plate 101. Moreover, although it has been carried out usually to use rivets in order to fix the facings (102, 102) on the core plate 101, using rivets has been associated with such drawbacks that the quantity of required component parts might increase and it might not be easy at all to automate the assembly operation.

Meanwhile, Japanese Unexamined Patent (KOKAI) Gazette No. 2010-223,294 discloses a dry friction material that can be used as the facings (102, 102) for the above-described conventional torque limiter. According to one of the techniques being disclosed in the publication, at least one of the core plate 101 and facings (102, 102) can be provided with positioners in order to position the core plate 101 with respect to the facing (102, 102), or vice versa, coaxially with each other. Consequently, it is possible to fix the facings (102, 102) on the core plate 101 without using any adhesive agent or rivets. The publication exemplifies irregular engagements, for instance, as for the positioners.

It is important for a torque limiter for vehicle as aforementioned to exhibit a predetermined friction coefficient stably in the frictional sliding operations. However, it is supposed that the facings (102, 102) might possibly be fastened or stuck onto the first rotary member 104 or second rotary member 105 because the facings (102, 102) are impregnated with water so that rust might possibly occur on the first rotary member 104 or second rotary member 105 when a vehicle travels in submerged areas or on muddy roads. Accordingly, measures like chemical treatments have been employed in order to inhibit the occurrence of rust. However, the chemical treatments require a great deal of man-hour requirements. It is desirable to make the first rotary member 104 and second rotary member 105 of stainless steel in order to solve the rust problem as well as to reduce the man-hour requirements.

Incidentally, it might be difficult to manufacture the first rotary member 104 and second rotary member 105 depending on their configurations, because stainless steels are one of the materials that are difficult comparatively to machine. Moreover, when providing a dry friction material, which makes the facings (102, 102), with dents, such as through holes, as the positioners, it is necessary to increase the using amount of reinforcement material, such as glass fibers, in order to avoid the decline of strength in the resultant facings (102, 102). However, increasing the using amount of glass fibers might possibly result in such a problem that the mating member, the first rotary member 104 and/or the second rotary member 105, is likely to rust, because the resulting facings (102, 102) might possibly be likely to be impregnated with water.

### SUMMARY OF THE INVENTION

The present invention has been developed in view of the aforementioned circumstances. It is therefore an object of the present invention to provide a torque limiter not only whose facings are fixed without using any adhesive agent or rivets, but also whose friction characteristics are little affected even when rust should have occurred on the facings' mating members, such as the above-described conventional first rotary member 104 and second rotary member 105.

A torque limiter for vehicle according to the present invention solves the above-described problems. The present torque limiter is disposed between a first rotary shaft and a second rotary shaft that are coaxial with each other, and comprises:

a first member being connected to the first rotary shaft, and extending diametrically outward;

a flat ring-shaped friction plate being connected to the second rotary shaft, extending diametrically outward, and facing the first member;

a second member being retained on the first member, and facing the friction plate on an opposite side with respect to the first member;

an urging member for pressing the second member toward the friction plate;

a first flat ring-shaped facing being retained on a surface of the first member that faces the friction plate, and being always pressed onto an opposite surface of the friction plate by the urging member;

a second flat ring-shaped facing being retained on a surface of the second member that faces the friction plate, and being always pressed onto another opposite surface of the friction plate by the urging member;

a first positioner being disposed in the first member and/or the first facing, thereby positioning the first member and the first facing coaxially with each other; and

a second positioner being disposed in the second member and/or the second facing, thereby positioning the second member and the second facing coaxially with each other.

The torque limiter for vehicle according to the present invention comprises the first member, the second member, the first facing, the second facing, and the friction plate. The first facing is retained on the first member. The second facing is retained on the second member. The first and second facings are always pressed onto the friction plate. Accordingly, the friction plate rotates synchronously with the first and second members. Moreover, the present torque limiter comes not to transmit torque fluctuations that are a predetermined value or more, because the first and second facings start sliding with respect to the friction plate when the torque fluctuations exceed the predetermined value. Consequently, the present torque limiter is not affected at all in the friction characteristics between the friction plate and the first and second facings, even if rust should have occurred on one of the first and second members so that one of the first and second facings should have fastened or stuck onto the one of the first and second members.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a cross-sectional diagram for illustrating an apparatus for absorbing torque fluctuations, apparatus which uses a torque limiter according to Embodiment No. 1 of the present invention.

FIG. 2 is an exploded perspective diagram for illustrating the present torque limiter according to Embodiment No. 1.

FIG. 3 is an exploded cross-sectional diagram for illustrating a major part of the present torque limiter according to Embodiment No. 1.

FIG. 4 is a cross-sectional diagram for illustrating a major part of a torque limiter according to Embodiment No. 2 of the present invention.

FIG. 5 is an exploded perspective diagram for illustrating a torque limiter according to Embodiment No. 3 of the present invention, in which a major part of the torque limiter is cut out imaginarily.

FIG. 6 is a plan view of first and second facings which are used in a torque limiter according to Embodiment No. 4 of the present invention.

FIG. 7 is a cross-sectional diagram for illustrating a major part of a torque limiter according to Embodiment No. 5 of the present invention.

FIG. 8 is a front view of a major part of a torque limiter according to Embodiment No. 6 of the present invention.

FIG. 9 is a front view of a major part of a torque limiter according to Embodiment No. 7 of the present invention.

FIG. 10 is a cross-sectional diagram being taken along the imaginary “10”-“10” chain line in FIG. 9.

FIG. 11 is a cross-sectional diagram for illustrating an apparatus for absorbing torque fluctuations, apparatus which uses a conventional torque limiter.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### Embodiments

A torque limiter for vehicle according to the present invention is disposed between a first rotary shaft and a second rotary shaft that are coaxial with each other. A hybrid driving system is given herein in order to describe the present torque limiter. The first rotary shaft can be one of the rotary shafts of an engine and electric motor. The second rotary shat can be the other one of the rotary shafts of the engine and electric motor. The present torque limiter is extremely effective for hybrid driving systems being equipped with both the engine and electric motor onboard, because torque fluctuations are likely to occur in them. The present torque limiter comprises a first member, a flat ring-shaped friction plate, a second member, an urging member, a first flat ring-shaped facing, a second flat ring-shaped facing, a first positioner, and a second positioner.

The first member is connected to the first rotary shaft, and extends diametrically outward. For example, a flywheel can make the first member when the engine's rotary shaft makes the first rotary shaft. The second member is retained on the first member, and rotates together with the first member. Moreover, the friction plate is put in place between the first member and the second member. In addition, the urging member urges the second member toward the friction plate.

The friction plate is formed as a flat ring shape. The friction plate transmits the rotations of the first member to the second rotary shaft by means of the frictional resistance resulting from the setup that the first and second facings, which are retained respectively on the first and second members, are always pressed onto the friction plate. However, when torque fluctuations exceed a predetermined value, each of the first and second facings starts sliding with respect to the friction plate, and so the friction plate comes not to transmit torque fluctuations having the predetermined value or more to the second rotary shaft. Therefore, it is preferable to make the friction plate of stainless steel, or metal whose surface has been subjected to a rust-preventive treatment, thereby inhibiting the friction plate from rusting. Thus, the friction plate can be inhibited from being fastened or stuck to the first and second facings, and thereby the sliding characteristics can be prevented from changing. Moreover, the friction plate can be readily manufactured even from out of stainless steel, because it has such a simple configuration as flat ring shapes.

The urging member urges the second member toward the friction plate. As the urging member, it is possible to exemplify coned disk springs, plate springs and coil springs, for instance. Note that it is preferable that the second member can be assembled with the first member movably relatively, with respect to the first member, in an axial direction of the first rotary shaft. Since the preferable setup makes the second member move in such a direction that it approaches the friction plate as the second facing wears down, the urging member can apply the urging force to the second member stably so that the second member can always be press contacted with the second facing stably.

Moreover, it is preferable that the friction plate can be assembled with the second rotary shaft movably relatively, in an axial direction of the second rotary shaft. Since the preferable setup makes the friction plate move in such a direction that it approaches the first member as the first facing wears down, the urging member can transmit the urging force to the friction plate by way of the second member and second facing stably so that the friction plate can always be press contacted with the first facing stably.

The first and second facings are retained on a surface of the first and second members that faces the friction plate, respectively. At least one of the first member and first facing, and at least one of the second member and second facing is provided with the first positioner and the second positioner, respectively. The first positioner is for positioning the first member and the first facing coaxially with each other, and the second positioner is for positioning the second member and the second facing coaxially with each other.

The first and second facings can be a so-called dry friction material, respectively, herein. The dry friction material is made from thermosetting resin, rubber and filler, and is manufactured as a flat ring-shaped configuration by pressure molding. As for the thermosetting resin, it is possible to exemplify phenol resins, and epoxy resins. In particular, modified phenol resins, to begin with melamine-modified phenol resins, can be a preferable option. Moreover, as for the rubber, it is possible to give synthetic rubbers, and natural rubbers. The synthetic rubbers can be acrylonitrile-butadiene rubbers, and styrene-butadiene rubbers. In addition, as for the filler, it is possible to name resin dust, calcium carbonate, and glass fibers.

The first and second facings can be manufactured in the following manner. First of all, a strand being impregnated with resin is formed by impregnating reinforcement fibers, such as glass fibers, with a liquid of uncured thermosetting resin. Subsequently, an unvulcanized rubber is mixed with a pigment, sulfur, a vulcanization accelerator agent, resin dust and calcium carbonate, thereby preparing a compounded rubber. The resulting compounded rubber is adhered onto the resin-impregnated strand in a predetermined amount. Then, the resin-impregnated strand with the compounded rubber adhered is rolled into a doughnut shape with a prescribed size. Finally, the resultant doughnut-shaped intermediate product is charged or pushed into a mold, and is subjected to press molding after being heated. Thus, the flat ring-shaped first and second facings can be obtained, respectively.

The first and second positioners are means for positioning the first and second members and the first and second facings coaxially with each other. It is possible to employ one of the following four types independently, or to combine a plurality of them to use. The urging member always presses the first facing onto the friction plate and first member, and the second facing onto the friction plate and second member. Therefore, it is possible to retain as well as fix the first and second facings on the first and second members, respectively, by simply positioning the first and second facings and the first and second members coaxially with each other with use of the first and second positioners, without ever making use of any adhesive agent or rivets.

(1) a first means for engaging a protuberance, with which the first member and/or the second member is provided, with a dent or through hole, with which the first facing and/or the second facing is provided;

(2) a second means for engaging a protuberance, with which the first facing and/or the second facing is provided, with a dent or through hole, with which the first member and/or the second member is provided;

(3) a third means for putting the outer circumferential rim of the first facing and/or the second facing along a positioning pin, with which the first member and/or the second member is provided, thereby placing the first facing and/or the second facing coaxially with the first member and/or the second member; and

(4) a fourth means for putting the inner circumferential rim of the first facing and/or the second facing along a positioning pin, with which the first member and/or the second member is provided, thereby placing the first facing and/or the second facing coaxially with the first member and/or the second member.

Although the first and second facings exhibit lower strength than does metal, it is feasible sufficiently to apply the second means to the first and second facings by setting up the number or configuration of the dents or through holes in the first member and/or the second member, or by changing the composition of their materials. However, such a second means cannot be as preferable as forming a dent or through hole in the first facing and/or the second facing, and then engaging the resulting dent or through hole with a protuberance that is formed on the first member and/or the second member, as set forth in the first means above. In this instance, however, one and only dent or through hole might be of no use in positioning the first and second members and the first and second facings coaxially with each other. If so, it is necessary to provide the first facing and/or the second facing with two or more dents or through holes at least, and then to engage the resultant dents or through holes with at least two or more protuberances with which the first member and/or the second member is provided at positions that correspond those of the dents or through holes. Moreover, in order to exert a uniform binding force to the first facing and/or the second facing, it is desirable to provide the first member and/or the second member with five or more protuberances at intervals of equal angles, and then to provide the first facing and/or the second facing with five or more dents or through holes at each of equivalent or identical angles over the entire circumference of the ring configuration. Note that it is needless to say that the protuberances can have a height that is less than a thickness that the first facing and/or the second facing exhibit when they have worn down due to the frictional sliding in service.

A shape of the dent or through hole, and that of the protuberance can preferably be formed as an identical configuration in the cross section in order to enhance the accuracy in positioning. Moreover, when the protuberance is made so as to fit into the dent or through hole, it is possible to firmly fix the first facing and/or the second facing to the first member and/or the second member, or vice versa. It is possible to exemplify the following setups as a makeup in which the protuberance is fit into the dent or through hole: a setup in which the protuberance is formed as a tapered configuration whose diameter becomes smaller as it comes toward the leading end, thereby engaging the protuberance with the dent or through hole at the trailing end; a setup in which the dent or through hole is formed as a tapered configuration whose inside diameter becomes smaller from the inlet to the deep inside, thereby engaging the inlet with the root end of the protuberance; and a setup in which an inner peripheral surface of the dent or through hole, or an outer peripheral surface of the protuberance is formed as a corrugated configuration in the cross section, thereby engaging the former with the later, or vice versa, at the crests of the resulting corrugated shape. In addition, it is possible to employ in order to fit the protuberance into the dent or through hole such a makeup that a circle connecting a plurality of the protuberances and another circle connecting a plurality of the dents or through holes are slightly displaced one another, or are slightly off-centered diametrically or put in place eccentrically one another.

When employing the aforementioned third or fourth means, it is possible to position the first and second members and the first and second facings by putting a plurality of positioning pins on a circumference of the first and second members and then putting the first and second facings along an inner periphery or outer periphery of the resultant positioning pins. If such is the case, it is desirable to prevent the first and second facings from moving relatively with respect to the first and second members in the circumferential direction in service. In order to do so, it is advisable to employ a setup in which the first or second means is adopted combinedly in addition to the third or fourth means. Moreover, an alternative method is also available in which a surface of the first and second facings coming in contact with the first and second members is processed to be highly frictional by increasing the rubber-component content therein so as to make the first and second facings less likely to slide against the first and second members.

In addition, it is even possible to give the positioning pins a hooked configuration that enables the resultant positioning pins to engage with the first and second facings partially.

### Embodiment Modes

Hereinafter, modes for embodying the present invention will be described in detail with reference to specific embodiments.

### Embodiment No. 1

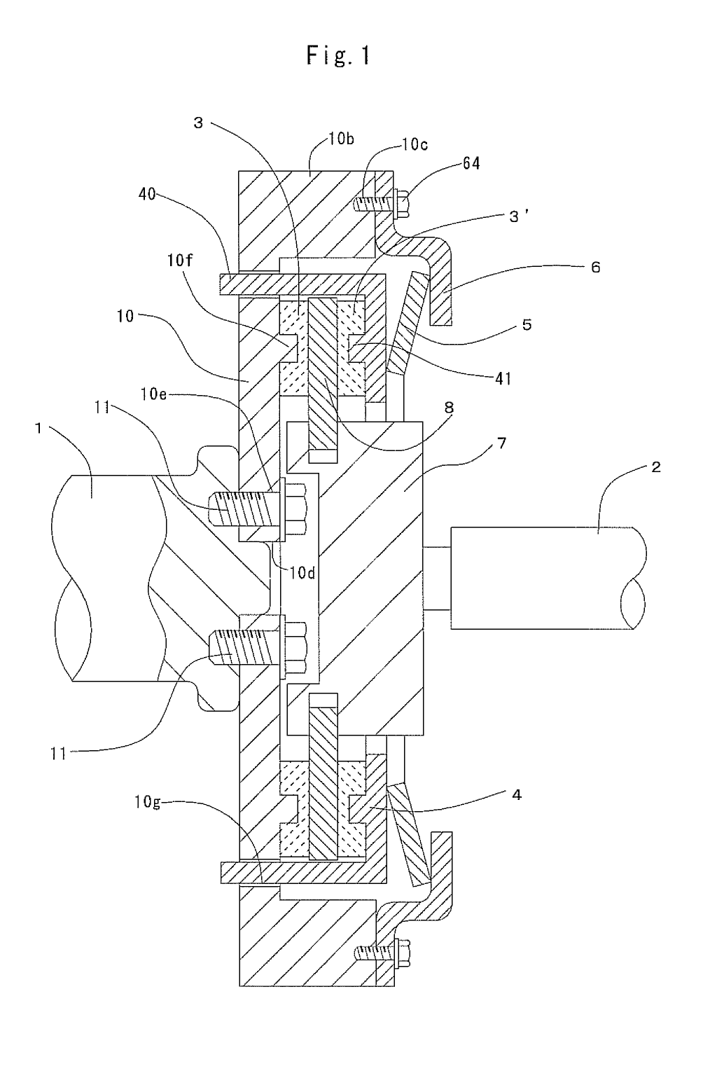

In FIG. 1, a cross-sectional diagram is shown, cross-sectional diagram which illustrates an apparatus for absorbing torque fluctuations. The apparatus uses a torque limiter that is directed to Embodiment No. 1 of the present invention. Moreover, the apparatus is employed in a hybrid automobile that has an engine and an electric motor onboard.

The apparatus for absorbing torque fluctuations is disposed between a first rotary shaft 1 and a second rotary shaft 2 that are put in place coaxially so as to face with each other. The apparatus not only transmits torques from the first rotary shaft 1 to the second rotary shaft 2, but also inhibits the torques from fluctuating when torque fluctuations occur. The first rotary shaft 1 is connected with and fixed to a flywheel 10. Note that the flywheel 10 serves as the claimed first member that extends diametrically outward. The flywheel 10 is formed as a disk shape, and is fixed coaxially by mounting bolts (11, 11) to the end face of the first rotary shaft 1 that is connected with an engine's output shaft.

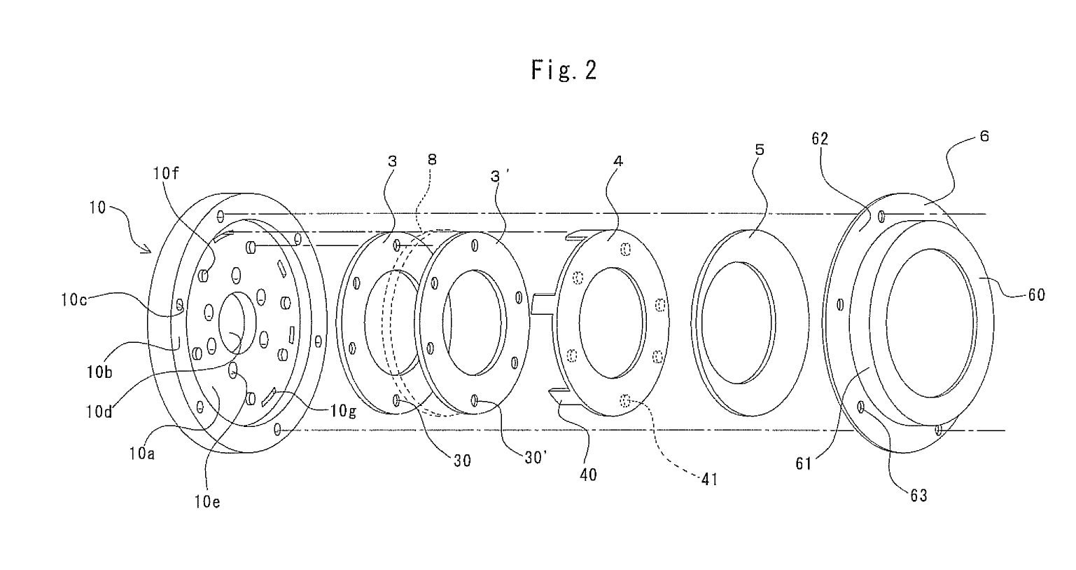

In FIG. 2, an exploded perspective diagram is shown, exploded perspective diagram which illustrates constituent parts to be mounted onto the first rotary shaft 1. The flywheel 10 is made of metal, and comprises a disk 10a, and a weight 10b. The weight 10b has a heavy thickness, and is formed as a ring shape around the circumferential periphery of the disk 10a. Moreover, the weight 10b is provided with six bolt holes 10c that are laid out at equal intervals in the circumferential direction. Meanwhile, the disk 10a is provided with a central hole 10d at the center, and is further provided with six through holes 10e, six column-shaped bosses 10f and six slits 10g around the central hole 10d. The central hole 10d pierces the disk 10a. The leading end of the first rotary shaft 1 is inserted into the central hole 10d. The through hole 10e pierce the disk 10a. The mounting bolts 11 penetrate the disk 10a through the through holes 10e. The slits 10g pierce the disk 10a. Moreover, the through holes 10e, the bosses 10f, and the slits 10g are formed in this order from the inner periphery of the disk 10a to the outer periphery. In addition, the through holes 10e, the bosses 10f, and the slits 10g are put in place on concentric circles in which the center of the disk 10a makes the center, respectively. Furthermore, the through holes 10e, the bosses 10f, and the slits 10g are further laid out at equal intervals in the circumferential direction, respectively.

Moreover, the flywheel 10 is further equipped with a flat ring-shaped first facing 3 that is put in place inside the weight 10b. The first facing 3 is formed as a flat ring shape with φ 220 mm in outside diameter, φ 190 mm in inside diameter and 2.4 mm in thickness, and is provided with six through holes 30. The through holes 30 pierce the first facing 3 from the front to the rear in the thickness-wise direction, and are laid out at equal intervals in the circumferential direction. Each of the bosses 10f on the flywheel 10 engages with each of the through holes 30 in the first facing 3, thereby retaining the first facing 30 on the flywheel 10.

In addition, the flywheel 10 is assembled with a pressure plate 4 being made of metal. Note that the metallic pressure plate 4 serves as the claimed second member. The pressure plate 4 is provided with six claws 40 on the outer circumferential rim. The claws 40 are formed to extend in the axial direction of the first rotary shaft 1. Moreover, the pressure plate 4 is further provided with six bosses 41 on the surface that faces the flywheel 10. The bosses 41 are aligned at equal intervals in the circumferential direction of the pressure plate 4 in the same manner as the bosses 10f of the flywheel 10 do. In addition, the bosses 41 engage with through holes 30′ in a second facing 3′ that is made identically with the first facing 3, thereby mounting the second facing 3′ onto the pressure plate 4. Moreover, the claws 40 of the pressure plate 4 are pierced through the slits 10g in the flywheel 10, thereby assembling the pressure plate 4 with the flywheel 10. In addition, the claws 40 are made movable relatively within the slits 10g in the axial direction of the first rotary shaft 1.

Note that the first and second facings (3, 3′) are manufactured in the following manner. A compounded rubber is adhered onto a strand, which has been impregnated with resin. The compounded rubber is made up of acrylonitrile-butadiene rubber, resin dust, calcium carbonate and sulfur. The strand, which has been impregnated with resin, is made up of melamine-modified phenol resin and glass fibers, for instance. The resulting resin-impregnated strand with the compounded rubber adhered is rolled into a doughnut shape with a prescribed size. Then, the resultant doughnut-shaped intermediate product is charged or pushed into a mold, and is press molded with a pressure of 15 MPa applied on the face after being heated to 165° C. Note that the through holes (30, 30′) are formed at the same time as the first and second facings (3, 3′) are molded.

The second rotary shaft 2 is assembled with a damper 7. The damper 7 is identical with the damper that is disclosed in Japanese Unexamined Patent Publication (KOKAI) Gazette No. 2002-13,547. The damper 7 transmits the torques of the first rotary shaft 1 to the second rotary shaft 2 via its own elastic resilient forces. That is, a plurality of coil springs (not shown) enable the damper 7 to contract elastically in the circumferential direction. Moreover, a friction plate 8 is fixed on an outer peripheral surface of the damper 7. The friction plate 8 is made of stainless steel, and is formed as a flat ring shape. The friction plate 8 is extended diametrically outward from the damper 7, and is thereby put in place so as to face the first facing 3 being retained on the flywheel 10 as well as the second facing 3′ being retained on the pressure plate 4.

The damper 7 is connected with the second rotary shaft 2 by spline. Accordingly, the damper 7 is made displaceable axially as the first and second facings (3, 3′) wear down.

In addition, a coned disk spring 5 serving as the claimed urging member, and a fixture plate 6 are assembled with each other on an outer side of the pressure plate 4, as shown in FIG. 1. Meanwhile, as illustrated in FIG. 2, the fixture plate 6 has a ring 60, a cylinder 61, and a flange 62. The ring 60 comes in contact with the outer rim of the coned disk spring 5, as shown in FIG. 1. The cylinder 61 extends from the ring 60 by the thickness (or height) of the coned disk spring 5. The flange 62 extends diametrically outward from the leading end of the cylinder 61. Moreover, the flange 62 is provided with six through holes 63 that are laid out at equal intervals in the circumferential direction. In addition, bolts 64 are pierced into the through holes 63 of the fixture plate 6, and are then screwed into bolt holes 10c of the flywheel 10, as shown in FIG. 1. Accordingly, the fixture plate 6 presses the coned disk spring 5 axially, and then the coned disk spring 5 in turn presses the pressure plate 4 axially. Consequently, the first and second facings (3, 3′) come in pressure contact with the friction plate 8, respectively.

Therefore, when torque fluctuations of the first rotary shaft 1 fall within a predetermined range, the friction plate B rotates synchronously with the first rotary shaft 1 because the first and second facings (3, 3′) come in pressure contact with the friction plate 8. That is, torques of the first rotary shaft 1 are conveyed to the damper 7 by way of the flywheel 10, the pressure plate 4, the first and second facings (3, 3′) and the friction plate 8. Then, the damper absorbs torque fluctuations, if any. Eventually, the torques of the first rotary shaft 1, specifically, the torques from which fluctuations have been absorbed, are transmitted to the second rotary shaft 2.

On the contrary, when the torque fluctuations of the first rotary shaft 1 exceed the predetermined value, namely, when they are more than an absorption capability that the damper 7 exhibits, slippage occurs between the first and second facings (3, 3′) and the friction plate 8. Thus, the torque transmission from the first rotary shaft 1 to the second rotary shaft 2 is shut off. As a result, it is possible to prevent excessive torque fluctuations from be ing transmitted from the first rotary shaft 1 to the second rotary shaft 1. To put it differently, the torque limiter according to Embodiment No. 1 is made up of the flywheel 10, the pressure plate 4, the first and second facings (3, 3′), the friction plate 8, the coned disk spring 5, and the fixture plate 6.

Even if water should have adhered onto the first and second facing (3, 3′) in service, it is possible to preemptively prevent the adhered water from turning into rust, which might fasten or stick the first and second facings (3, 3′) onto the friction plate 8, because the friction plate 8 is made of stainless steel. Moreover, even if rust should have occurred on the flywheel 10 or pressure plate 4 so that the first or second facing (3, 3′) should have fastened or stuck onto the flywheel 10 or pressure plate 4, no problems arise from the fastening or sticking at all, because the first and second facings (3, 3′) are not only retained but also fixed on the flywheel 10 and pressure plate 4, respectively.

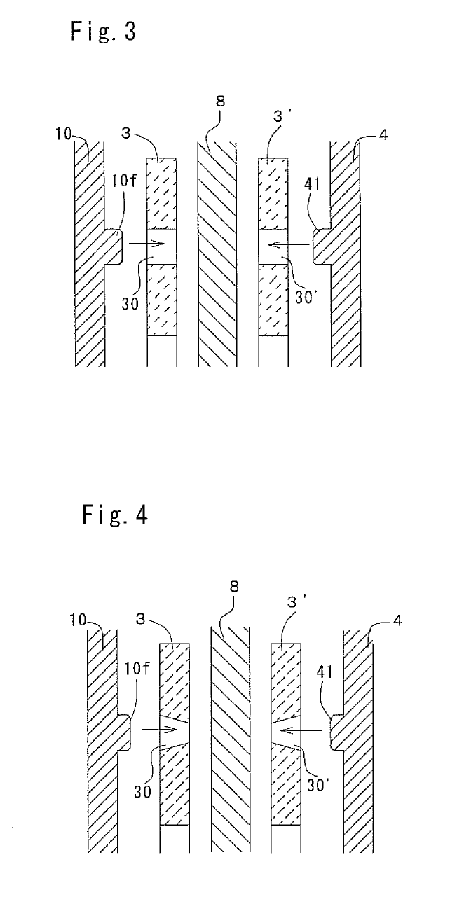

As illustrated in an enlarged manner in FIG. 3, the through holes (30, 30′) of the first and second facings (3, 3′) are formed respectively as a true-circled shape, and the bosses (10f, 41) of the flywheel 10 and pressure plate 4 are formed respectively as a true-circled shaped in the cross section. Moreover, both of the through holes (30, 30′) and bosses (10f, 41) have an identical diameter (e.g., φ 5 mm), respectively. Therefore, it is possible to mount the first and second facings (3, 3′) onto the flywheel 10 and pressure plate 4 respectively with higher positioning accuracy by simply inserting the bosses (10f, 41) of the flywheel 10 and pressure plate 4 into the through holes (30, 30′) of the first and second facings (3, 3′). In addition, the first and second facings (3, 3′), and the flywheel 10 and pressure plate 4 are designed so as not to have the bosses (10f, 41) come in contact with the friction plate 8, even if the first and second facings (3, 3′) should have worn down, because the height of the bosses (10f, 41) is set to be 1.2 mm, for instance, which makes 50% of the length of the through holes (30, 30′) (or the thickness of the first and second facings (3, 3′)). Note that the bosses (10f, 41) can preferably have a height that is shorter than the length of the through holes (30, 30′) by from 30% to 70%, more preferably by from 50% to 70%.

### Embodiment No. 2

A torque limiter for vehicle according to Embodiment No. 2 of the present invention comprises the same constituent elements as those of the torque limiter according to Embodiment No. 1, except that the first and second facings (3, 3′) are provided with the through holes (30, 30′) that have a different shape from those of the first and second facings (3, 3′) in the torque limiter according to Embodiment No. 1. Hence, descriptions will be hereinafter made on the distinctive feature alone.

As illustrated in FIG. 4, the through holes (30, 30′) are formed as a tapered shape whose diameter gets smaller from the inlet side facing the bosses (10f, 41) toward the outlet side facing the friction plate 8. For example, the through holes (30, 30′) had an inlet-side diameter of φ 5 mm that is equal to those in Embodiment No. 1, and an outlet-side diameter φ 3 mm. Therefore, as the bosses (10f, 41) with a diameter of φ 5 mm are inserted respectively into the through holes (30, 30′), the bosses (10f, 41) press and then expand the through holes (30, 30′). As a result, the first and second facings (3, 3′) are upgraded in the strength for mounting them onto the flywheel 10 and pressure plate 4, because the binding force increases between the first and second facings (3, 3′) and the flywheel 10 and pressure plate 4.

### Embodiment No. 3

A torque limiter for vehicle according to Embodiment No. 3 of the present invention comprises the same constituent elements as those of the torque limiter according to Embodiment No. 1, except that the first and second facings (3, 3′) are provided with the through holes (30, 30′) that have a different inside diameter from those of the first and second facings (3, 3′), and that the flywheel 10 and pressure plate 4 are provided with the bosses (10f, 41) that have a different shape from those of the flywheel 10 and pressure plate 4 in the torque limiter according to Embodiment No. 1. Hence, descriptions will be hereinafter made on the distinctive features alone.

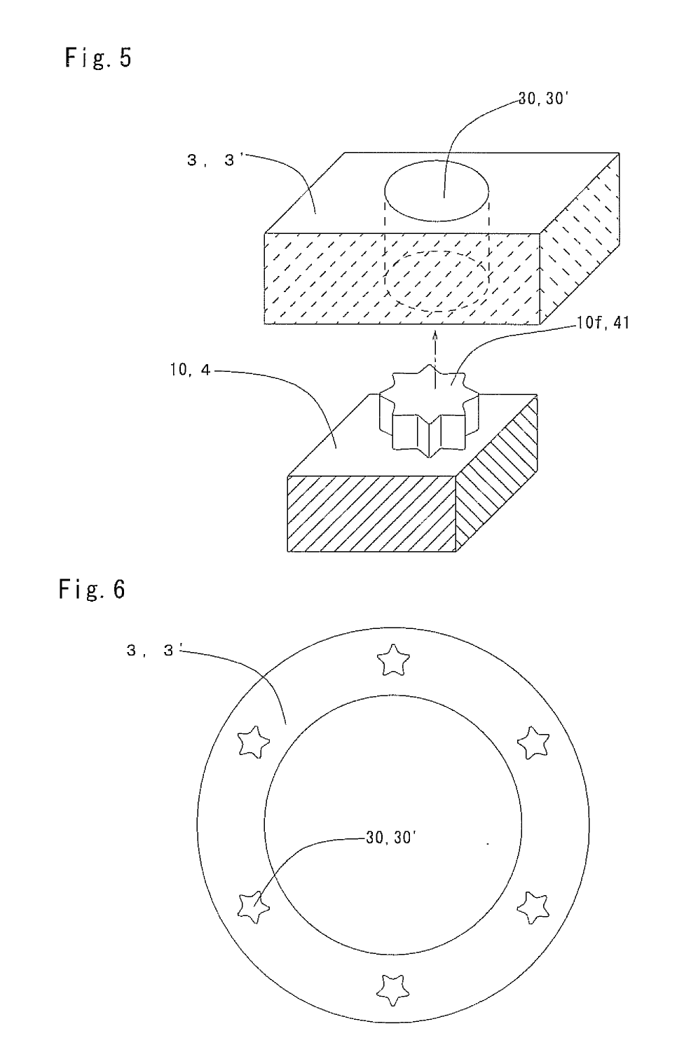

As illustrated in FIG. 5, the bosses (10f, 41) are formed as a star shape in the cross section. The star shape has an outer periphery in which dents and protuberances lie one after another. For example, the bosses (10f, 41) have a maximum diameter of φ 7 mm, and a minimum diameter of φ 5 mm. Moreover, the through holes (30, 30′) have an inside diameter of φ 6 mm, for instance. Therefore, as the bosses (10f, 41) are inserted respectively into the through holes (30, 30′), the bosses (10f, 41) press and then expand the through holes (30, 30′) at the protuberances on the outer periphery. As a result, the first and second facings (3, 3′) are upgraded in the strength for mounting them onto the flywheel 10 and pressure plate 4, because the binding force increases between the first and second facings (3, 3′) and the flywheel 10 and pressure plate 4.

### Embodiment No. 4

A torque limiter for vehicle according to Embodiment No. 4 of the present invention comprises the same constituent elements as those of the torque limiter according to Embodiment No. 1, except that the first and second facings (3, 3′) are provided with the through holes (30, 30′) that have a different shape from those of the first and second facings (3, 3′), and that the flywheel 10 and pressure plate 4 are provided with the bosses (10f, 41) that have a different outside diameter from those of the flywheel 10 and pressure plate 4 in the torque limiter according to Embodiment No. 1. Hence, descriptions will be hereinafter made on the distinctive features alone.

As illustrated in FIG. 6, the through holes (30, 30′) are formed as a star shape in the cross section. The star shape has an inner periphery in which dents and protuberances lie one after another. For example, the through holes (30, 30′) have a maximum inside diameter of 7 mm, and a minimum inside diameter of φ 5 mm. Moreover, the bosses (10f, 41) have an outside diameter of φ 6 mm, for instance. Therefore, as the bosses (10f, 41) are inserted respectively into the through holes (30, 30′), the bosses (10f, 41) press and then expand the minimum-inside-diameter sections of the through holes (30, 30′). As a result, the first and second facings (3, 3′) are upgraded in the strength for mounting them onto the flywheel 10 and pressure plate 4, because the binding force increases between the first and second facings (3, 3′) and the flywheel 10 and pressure plate 4.

### Embodiment No. 5

A torque limiter for vehicle according to Embodiment No. 5 of the present invention comprises the same constituent elements as those of the torque limiter according to Embodiment No. 1, except that the first and second facings (3, 3′) are provided with the through holes (30, 30′) that have a different shape from those of the first and second facings (3, 3′) in the torque limiter according to Embodiment No. 1, and that the first and second facings (3, 3′) further includes extra constituent elements, O rings. Hence, descriptions will be hereinafter made on the distinctive features alone.

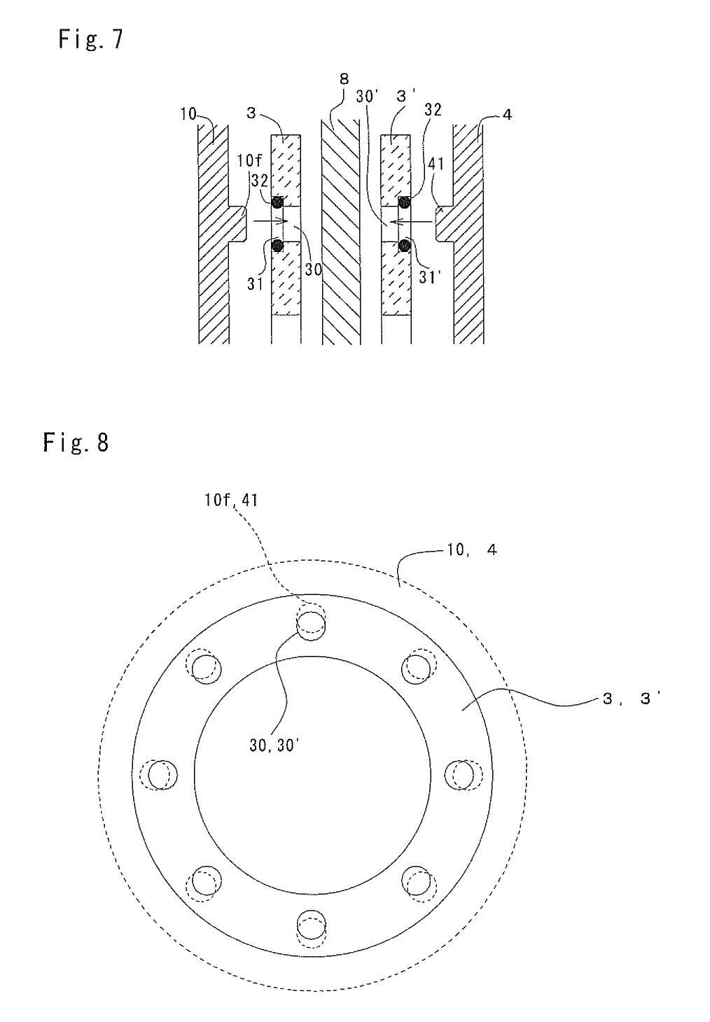

As illustrated in FIG. 7, the through holes (30, 30′) are provided with major-inside-diameter sections (31, 31′), respectively, at the inlet sides that face the flywheel 10 and pressure plate 9. The major-inside-diameter sections (31, 31′) have an inside diameter that is larger than the inside diameter of the other sections in the through holes (30, 30′). Moreover, O rings 32 are put in place at the major-inside-diameter sections (31, 31′). In addition, the O rings 32 have an inside diameter that is slightly smaller than the outside diameter of the bosses (10f, 41). Therefore, the O rings 32 hold the bosses (10f, 41) in place when the bosses (10f, 41) are inserted respectively into the through holes (30, 30′). As a result, the first and second facings (3, 3′) are upgraded in the strength for mounting them onto the flywheel 10 and pressure plate 4.

### Embodiment No. 6

A torque limiter for vehicle according to Embodiment No. 6 of the present invention comprises the same constituent elements as those of the torque limiter according to Embodiment No. 1, except that the flywheel 10 and pressure plate 4 are provided with the bosses (10f, 41) that are laid out differently from those of the flywheel 10 and pressure plate 4 in the torque limiter according to Embodiment No. 1. Hence, descriptions will be hereinafter made on the distinctive feature alone.

In the torque limiter according to Embodiment No. 1, each of the six bosses (10f, 41) has an axial center that is positioned on the circumference of an imaginary circle. Moreover, the resulting imaginary circle is identical to or concentric with another imaginary circle that is made by connecting the centers of through holes (30, 30′) of the first and second facings (3, 3′). However, in the present torque limiter according to Embodiment No. 6, the imaginary circle, which is made by connecting the centers of the six bosses (10f, 41) in each of the flywheel 10 and pressure plate 4, is designed to have a diameter that is slightly larger than that of the other imaginary circle, which is made by connecting the centers of the six through holes (30, 30′) in each of the first and second facings (3, 3′), as shown in FIG. 8. Therefore, when the bosses (10f, 41) are inserted into the through holes (30, 30′) respectively, the bosses (10f, 41) are fit into the through holes (30, 30′) so as to expand the through holes (30, 30′) diametrically outward. As a result, it is possible to upgrade the strength for mounting the first and second facings (3, 3′) onto the flywheel 10 and pressure plate 4, because the bosses (10f, 41) apply expanding forces to the first and second facings (3, 3′) uniformly over the entire circumference.

### Embodiment No. 7

A torque limiter for vehicle according to Embodiment No. 7 of the present invention comprises the same constituent elements as those of the torque limiter according to Embodiment No. 1, except that the first and second facings (3, 3′) are different from those in the torque limiter according to Example No. 1 in the shape and construction as well as in the setup for mounting them onto the flywheel 10 and pressure plate 4. Hence, descriptions will be hereinafter made on the distinctive features alone.

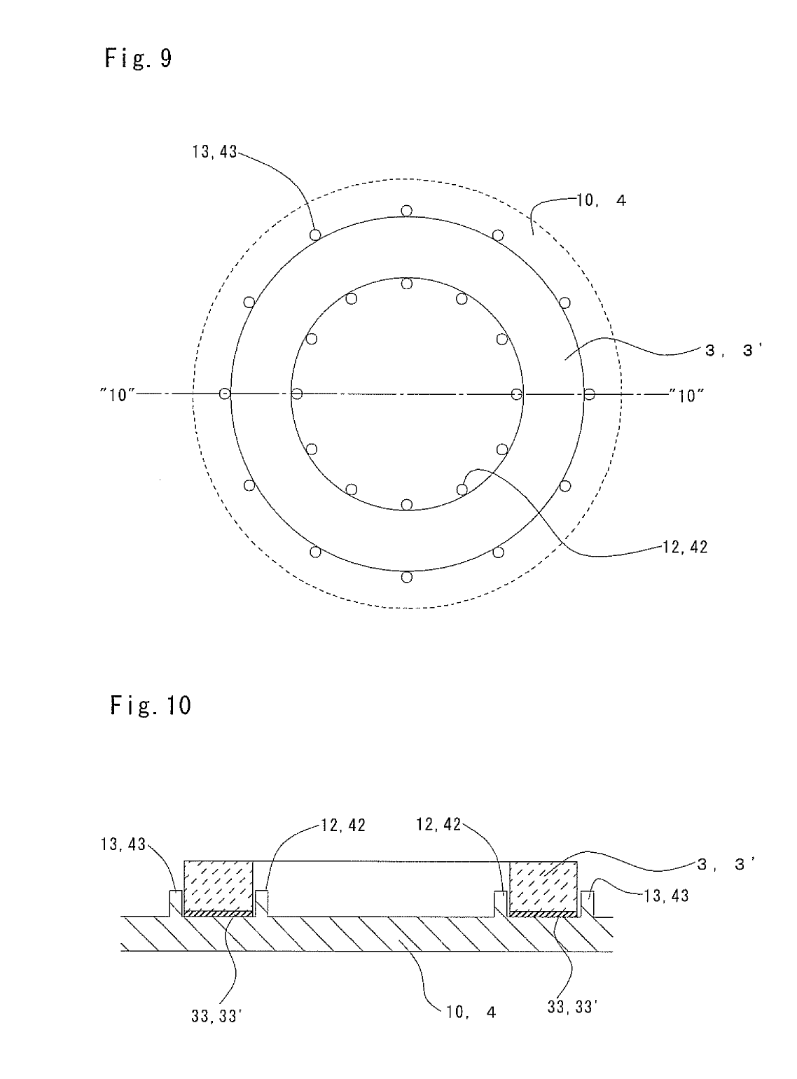

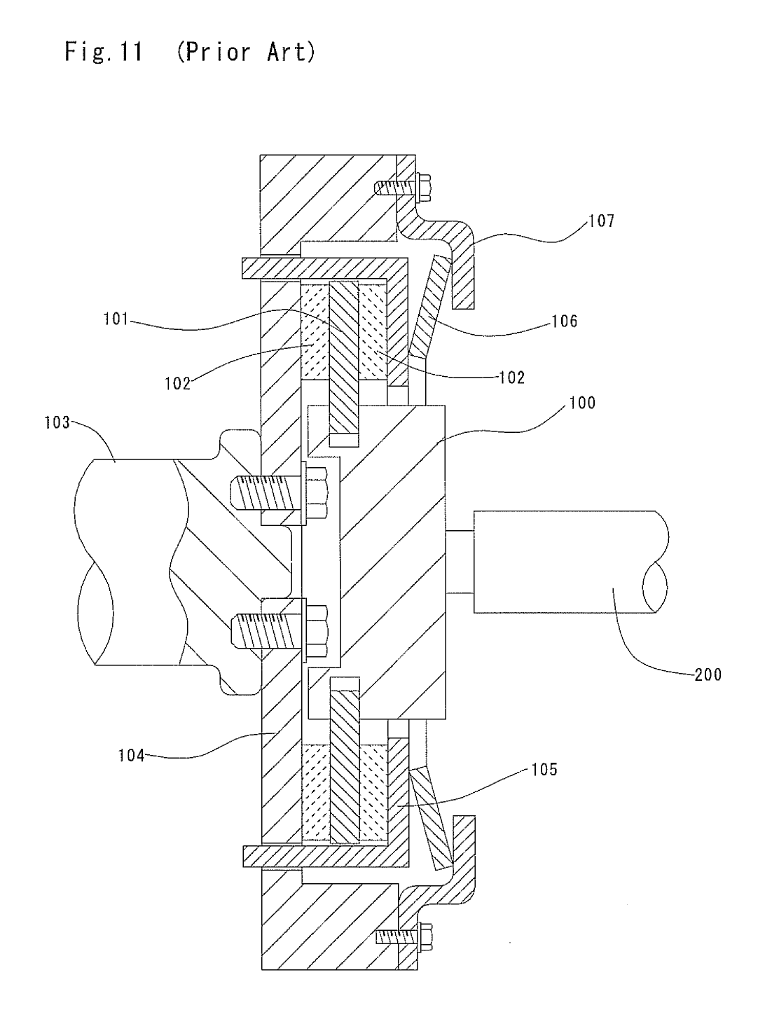

As illustrated in FIGS. 9 and 10, the flywheel 10 and pressure plate 4 are provided with a plurality of inner-periphery positioning pins (12, 42) and a plurality of outer-periphery positioning pins (13, 43), respectively, instead of the bosses (10f, 41). The inner-periphery positioning pins (12, 42) are disposed upright at positions where the inner-periphery positioning pins (12, 42) come in contact with the inner peripheral rim of the first and second facings (3, 3′). The outer-periphery positioning pins (13, 43) are disposed upright at positions where the outer-periphery positioning pins (13, 43) come in contact with the outer peripheral rim of the first and second facings (3, 3′). The inner-periphery positioning pins (12, 42), and the outer-periphery positioning pins (13, 43) have a height that makes about 50% of the thickness of the first and second facings (3, 3′). Moreover, the first and second facings (3, 3′) are free of the through holes (30, 30′), but are provided with rubber layers (33, 33′) on one of the opposite surfaces. Note that the rubber layers (33, 33′) are formed of a blended rubber alone. The rubber layer 33 is retained between the inner-periphery positioning pins 12 and the outer-periphery positioning pins 13 so as to come in contact with the flywheel 10. The rubber layer 33′ is retained between the inner-periphery positioning pins 42 and the outer-periphery positioning pins 43 so as to come in contact with the pressure plate 4. Moreover, similarly to the bosses (10f, 41), the inner-periphery positioning pins (12, 42) and outer-periphery positioning pins (13, 43) can preferably have a height that is shorter than the thickness of the first and second facings (3, 3′) by from 30% to 70%, more preferably by from 50% to 70%.

The present torque limiter according to Embodiment No. 7 comprises the inner-periphery positioning pins (12, 42) and outer-periphery positioning pins (13, 43) that make it possible to mount the first and second facings (3, 3′) onto the flywheel 10 and pressure plate 4 with higher positioning accuracy. Moreover, a larger friction coefficient is exhibited between the rubber layers (33, 33′) and the flywheel 10 and pressure plate 4, because the former comes in press contact with the latter. All in all, it is possible to prevent the first and second facings (3, 3′) from moving relatively with respect to the flywheel 10 and pressure plate 4 in the circumferential direction.

Note that, in addition to the first and second facings (3, 3′) that are directed to Embodiment No. 7, the first and second facings (3, 3′) that are directed to other Embodiment No. 1 through No. 6 can preferably be provided with the rubber layers (33, 33′) as well. Since the rubber layers (33, 33′) being formed as described above can reliably inhibit the first and second facings (3, 3′) from moving relatively with respect to the flywheel 10 and pressure plate 4, it is possible to prevent drawbacks that result from the through holes (30, 30′) that should have been deformed. Moreover, it is even fine to provide the first and second facings (3, 3′) with an adhesive coating layer, respectively, ins t e ad of the rubber layers (33, 33′). Since the resulting adhesive layers are soft, it is possible to produce a friction coefficient between the adhesive coating layers and the flywheel 10 and pressure plate 4 in the same manner as the rubber layers (33, 33′) do.

Moreover, in the present torque limiter according to Embodiment No. 7, both of the inner-peripheral positioning pins (12, 42) and outer-peripheral positioning pins (13, 43) not only position the first and second facings (3, 3′) with respect to the flywheel 10 and pressure plate 4, but also retain the former on the latter. Note, however, that either one of the inner-peripheral positioning pins (12, 42) and outer-peripheral positioning pins (13, 43) alone can operate similarly to effect the same advantage as above.

### INDUSTRIAL APPLICABILITY

A torque limiter according to the present invention can be applied suitably to dampers for hybrid driving system, for instance.

Having now fully described the present invention, it will be apparent to one of ordinary skill in the art that many changes and modifications can be made thereto without departing from the spirit or scope of the present invention as set forth herein including the appended claims.

What is claimed is:

1. A torque limiter for vehicle, the torque limiter being disposed between a first rotary shaft and a second rotary shaft that are coaxial with each other, and the torque limiter comprising:
a first member being connected to the first rotary shaft, and extending diametrically outward;
a flat ring-shaped friction plate being connected to the second rotary shaft, extending diametrically outward, and facing the first member;
a second member being retained on the first member, and facing the friction plate on an opposite side with respect to the first member;
an urging member for pressing the second member toward the friction plate;
a first flat ring-shaped facing being retained on a surface of the first member that faces the friction plate, and being always pressed onto an opposite surface of the friction plate by the urging member;
a second flat ring-shaped facing being retained on a surface of the second member that faces the friction plate, and being always pressed onto another opposite surface of the friction plate by the urging member;
a first positioner being disposed in the first member and/or the first facing, thereby positioning the first member and the first facing coaxially with each other; and
a second positioner being disposed in the second member and/or the second facing, thereby positioning the second member and the second facing coaxially with each other.

2. The torque limiter according to claim 1, wherein the friction plate is made of stainless steel, or metal whose surface has been subjected to a rust-preventive treatment.

3. The torque limiter according to claim 1, wherein:
the friction plate is assembled with the second rotary shaft movably relatively, in an axial direction of the second rotary shaft; and
the second member is assembled with the first member movably relatively, with respect to the first member, in an axial direction of the first rotary shaft.

4. The torque limiter according to claim 1, wherein the first and second positioners comprise:
a dent being disposed at two or more locations in the first and second facings; and
a protuberance being disposed at two or more locations on the first and second members so as to protrude from the first and second members and then engage with the dent.

5. The torque limiter according to claim 1, wherein the first and second positioner comprise a plurality of positioning pins protruding from the first and second members and then coming in contact with at least one of an outer circumferential rim and inner circumferential rim of the first and second facings.

6. The torque limiter according to claim 4, wherein:
a through hole makes the dent; and
a boss makes the protuberance.

7. The torque limiter according to claim 6, wherein the through hole tapers from wide to narrow in the direction away from the first and second members.

8. The torque limiter according to claim 4, wherein:
the dent has a depth; and
the protuberance has a height falling in a range of from 30% to 70% of the depth of the dent.

9. The torque limiter according to claim 1, wherein the first positioner, and the second positioner are put in place eccentrically to each other.

10. The torque limiter according to claim 1 being free from any adhesive agent for bonding the first facing and/or the second facing onto the first member and/or the second member.

11. The torque limiter according to claim 1 being free from any rivet for mounting the first facing and/or the second facing onto the first member and/or the second member.
